(19) United States
(12) Patent Application Publication
(10) Pub. No.: US 2026/0138678 A1
(43) Pub. Date: May 21, 2026

(54) VEHICLE FRAME STRUCTURE

(71) Applicant: TOYOTA JIDOSHA KABUSHIKI KAISHA, Toyota-shi (JP)

(72) Inventors: Kohei Noda, Toyota-shi (JP); Shigenori Hashida, Nisshin-shi (JP)

(73) Assignee: TOYOTA JIDOSHA KABUSHIKI KAISHA, Toyota-shi (JP)

(21) Appl. No.: 19/332,251

(22) Filed: Sep. 18, 2025

(30) Foreign Application Priority Data
Nov. 21, 2024 (JP) 2024-203429

(51) Int. Cl. B62D 25/18

(52) U.S. Cl. CPC B62D 25/18

(57) ABSTRACT

The vehicle frame structure includes a frame main body that is integrally cast to include a wheel house section, a flange section provided along an upper edge of the wheel house section, an inclined surface provided on an upper portion of the wheel house section and below the flange section and having a through-hole, and at least one reinforcing rib connecting the inclined surface and the flange section.

### CROSS-REFERENCE TO RELATED APPLICATION

This application claims priority to Japanese Patent Application No. 2024-203429 filed on Nov. 21, 2024. The disclosure of the above-identified application, including the specification, drawings, and claims, is incorporated by reference herein in its entirety.

### BACKGROUND

### 1. Technical Field

The present disclosure relates to a vehicle frame structure.

### 2. Description of Related Art

Japanese Unexamined Patent Application Publication No. 9-175433 (JP 9-175433 A) discloses a structure including a wheel house shell in which a wheel house and a side member are integrally formed, and a reinforcing rib is provided in the wheel house.

### SUMMARY

Meanwhile, a technique of forming a frame including a wheel house of a vehicle by casting is known. In a case where a through-hole is formed in such a frame, it is common to form the through-hole by processing the frame after casting. However, the periphery of a processed portion may be deformed during the formation of the through-hole.

An object of the present disclosure is to obtain a vehicle frame structure in which deformation of the periphery of a through-hole can be inhibited in a frame formed by casting.

A vehicle frame structure according to claim 1 includes:
a frame main body that is integrally cast to include a wheel house section;
a flange section provided along an upper edge of the wheel house section;
an inclined surface provided in an upper portion of the wheel house section and below the flange section, the inclined surface being provided with a through-hole; and
one or more reinforcing ribs that connect the inclined surface and the flange section.

In the vehicle frame structure according to claim 1, the frame main body is integrally cast to include the wheel house section, and the flange section is provided along the upper edge of the wheel house section. In addition, the inclined surface is provided in the upper portion of the wheel house section and below the flange section, and the inclined surface is provided with the through-hole. Further, the inclined surface and the flange section are connected by the one or more reinforcing ribs. As a result, the periphery of the through-hole is reinforced, and deformation can be inhibited even in a case where the through-hole is formed after casting.

According to claim 2, in the vehicle frame structure in claim 1, a plurality of the reinforcing ribs is provided, and each of the reinforcing ribs is connected to a ridge line between the inclined surface and a surface adjacent to the inclined surface.

In the vehicle frame structure according to claim 2, the reinforcing ribs are connected to the ridge line between the inclined surface and the surface adjacent to the inclined surface, and thus the inclined surface can be effectively reinforced.

According to claim 3, in the vehicle frame structure in claim 1, a front rib is provided forward of the reinforcing ribs in a vehicle front-rear direction and a rear rib is provided rearward of the reinforcing ribs in the vehicle front-rear direction, in the flange section.

In the vehicle frame structure according to claim 3, the entirety of the flange section can be reinforced by the front rib and the rear rib.

According to claim 4, in the vehicle frame structure in claim 3, the flange section is arch-shaped, and the through-hole is provided in an uppermost portion of the wheel house section.

In the vehicle frame structure according to claim 4, even in a case where the through-hole is provided in a portion having a relatively low strength in the uppermost portion of the wheel house section, the insufficient strength can be compensated for by the reinforcing ribs.

According to claim 5, in the vehicle frame structure in claim 4, a plurality of the front ribs and a plurality of the rear ribs are provided, and the front ribs and the rear ribs are radially disposed.

In the vehicle frame structure according to claim 5, since the front ribs and the rear ribs are radially disposed, a material, such as aluminum, easily flows during casting.

As described above, with the vehicle frame structure according to the present disclosure, the deformation of the periphery of the through-hole can be inhibited in a frame formed by casting.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a main part of a vehicle frame structure according to an embodiment.

### DETAILED DESCRIPTION OF EMBODIMENTS

A vehicle frame structure according to an embodiment will be described with reference to the drawings.

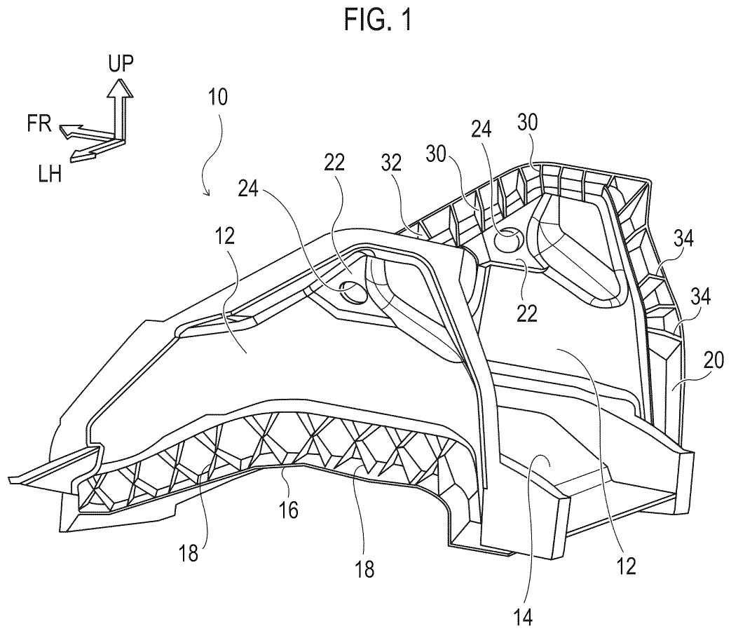

FIG. 1 is a perspective view showing a main part of a vehicle frame structure according to an embodiment. In addition, an arrow FR, an arrow UP, and an arrow LH in the figure respectively indicate a vehicle front direction, a vehicle up direction, and a vehicle left direction in the vehicle. In the following description, when the front and rear, the up and down, and the right and left directions are used without special mention, the vehicle front-rear direction, the vehicle up-down direction, and the right and left direction (width direction) of the vehicle indicate the front and rear, the up and down, and the right and left directions, respectively.

As shown in FIG. 1, the frame main body 10 that constitutes the vehicle frame structure is a component disposed at the rear portion of the vehicle and is formed by casting including a wheel house section 12. In the present embodiment, a case where the vehicle frame structure is applied to the rear portion of the vehicle is described, but the present embodiment is not limited thereto, and the vehicle frame structure may be applied to the front portion of the vehicle. In this case, the vehicle frame structure is integrally formed by casting including a front wheel house.

The wheel house sections 12 are provided in a pair of right and left, and extend in a vehicle front-rear direction and a vehicle up-down direction, respectively. In addition, lower end portions of the right and left wheel house sections 12 are connected to each other in the vehicle width direction by the rear panel portion 14.

A rear side member portion 16 extending in a vehicle front-rear direction is provided at a lower end portion of the wheel house section 12. The rear side member portion 16 is integrally formed by casting with the wheel house section 12, and a plurality of lower ribs 18 is provided on the surface of the rear side member portion 16 on the outside in the vehicle width direction along the vehicle front-rear direction.

The lower ribs 18 are provided at intervals in the vehicle front-rear direction, and are provided in a substantially X shape as viewed in the vehicle width direction.

Here, an outer edge of the wheel house section 12 is formed in a substantially arch shape in which a central portion of the wheel house section 12 in the vehicle front-rear direction bulges upward with respect to the vehicle width direction, and a flange section 20 is provided along an upper edge of the wheel house section 12.

The flange section 20 is provided over the entire region of the outer edge of the wheel house section 12 and extends from the outer edge of the wheel house section 12 to the vehicle-up side. In addition, a plurality of bolt holes (not shown) is provided in the flange section 20, and the peripheral component is fastened to the wheel house section 12 by inserting bolts into the bolt holes.

An inclined surface 22 is provided on an uppermost portion of the wheel house section 12. The inclined surface 22 is provided below the flange section 20 and is inclined toward the inner side in the vehicle width direction as going from the vehicle upper side to the vehicle lower side. In addition, a ridge line is provided between the inclined surface 22 and the surface adjacent to the inclined surface 22.

A through-hole 24 is provided in the inclined surface 22. The through-holes 24 are circular holes formed to vertically penetrate the inclined surface 22. In the present embodiment, as an example, the through-holes 24 are formed by processing after casting, and a harness, a brake wire, a cooling pipe, and the like (not shown) are passed through the through-holes 24. Then, a part of the vehicle outside and a part of the vehicle inside are connected through the through-holes 24 by a harness, a brake wire, a cooling pipe, or the like. The through-holes 24 may be used for passing a welding gun in the assembly step, or may be used as a service hole for accessing a part, such as a bolt.

Here, a plurality of reinforcing ribs 30 is provided in the flange section 20. The reinforcing rib 30 is provided on the surface of the flange section 20 on the inner side in the vehicle width direction and links the inclined surface 22 and the flange section 20. In the present embodiment, as an example, four reinforcing ribs 30 are provided, but the number of reinforcing ribs 30 is not particularly limited.

Here, among the four reinforcing ribs 30, the most front reinforcing rib 30 and the most rear reinforcing rib 30 are connected to the ridge line between the inclined surface 22 and the surface adjacent to the inclined surface 22 in the wheel house section 12.

A front rib 32 is provided in a portion of the vehicle in front of the reinforcing rib 30, and a rear rib 34 is provided in a portion of the vehicle behind the reinforcing rib 30. The front rib 32 is provided on a surface of the flange section 20 on the inner side in the vehicle width direction in front of the inclined surface 22 with respect to the vehicle.

The rear rib 34 is provided on a surface of the flange section 20 on the inner side in the vehicle width direction, in a portion of the vehicle behind the inclined surface 22. The reinforcing rib 30, the front rib 32, and the rear rib 34 are disposed substantially radially as viewed in the vehicle width direction.

### Action

Next, the operation of the vehicle frame structure according to the present embodiment will be described.

In the present embodiment, the frame main body 10 is integrally formed by casting including the wheel house section 12, and the flange section 20 is provided along the upper edge of the wheel house section 12. In addition, an inclined surface 22 is provided on an upper portion of the wheel house section 12 and below the flange section 20, and a through-hole 24 is provided in the inclined surface 22. Further, the inclined surface 22 and the flange section 20 are linked by at least one reinforcing rib 30. As a result, the periphery of the through-hole 24 is reinforced, and deformation can be suppressed even in a case where the through-hole 24 is formed after casting.

In the present embodiment, since the reinforcing rib 30 is connected to the ridge line of the surface adjacent to the inclined surface 22, the inclined surface 22 can be effectively reinforced.

Further, in the present embodiment, an entirety of the flange section 20 can be reinforced by the front rib 32 and the rear rib 34 provided on the front and rear sides of the reinforcing rib 30.

Further, in the present embodiment, even in a case where the through-holes 24 are provided in the portion having a relatively low strength at the uppermost portion of the wheel house section 12, the insufficient strength can be compensated for by the reinforcing ribs 30.

In the present embodiment, since the front rib 32 and the rear rib 34 are radially disposed, the material, such as aluminum, easily flows during casting. That is, the flowability of the molten metal can be improved.

Although the vehicle frame structure according to the present disclosure has been described above, the present disclosure can be carried out in various aspects within a scope not departing from the gist of the present disclosure. For example, in the present embodiment, the reinforcing ribs 30, the front rib 32, and the rear rib 34 are provided on the surface of the flange section 20 on the inner side in the vehicle width direction, but the present disclosure is not limited thereto, and ribs may be provided on the surface of the flange section 20 on the inner side in the vehicle width direction. In this case, the fluidity of the molten metal during casting can be further improved.

In the present embodiment, the reinforcing rib 30 is connected to the ridge lines on the front and rear sides of the inclined surface 22, but the present disclosure is not limited thereto. For example, the reinforcing rib 30 may be connected to solely one of the front and rear ridge lines with respect to the inclined surface 22. In addition, a structure in which the reinforcing rib 30 is connected to the vicinity of the ridge line may be adopted.

Further, in the present embodiment, the inclined surface 22 and the through-holes 24 are provided in the uppermost portion of the wheel house section 12, but the present disclosure is not limited thereto, and the inclined surface 22 may be provided in another portion. Further, the shape of the through-holes 24 is not limited to a circular hole, and may be another shape, and the number of the through-holes 24 is not particularly limited.

In the above-described embodiment, the following appendix is disclosed.

### (Appendix 1)

A vehicle frame structure including:
a frame main body that is integrally formed by casting and includes a wheel house section;
a flange section that is provided along an upper edge of the wheel house section;
an inclined surface that is provided in an upper portion of the wheel house section and below the flange section and has a through-hole; and
at least one reinforcing rib that links the inclined surface and the flange section.

### (Appendix 2)

The vehicle frame structure according to Appendix 1, in which a plurality of the reinforcing ribs is provided, and each of the reinforcing ribs is connected to a ridge line between the inclined surface and an adjacent surface.

### (Appendix 3)

The vehicle frame structure according to Appendix 1 or 2, in which a front rib is provided in a portion of the vehicle in front of the reinforcing rib, and a rear rib is provided in a portion of the vehicle behind the reinforcing rib, in the flange section.

### (Appendix 4)

The vehicle frame structure according to Appendix 3, in which:
the flange section is formed in an arch shape; and
the through-hole is provided in an uppermost portion of the wheel house section.

### (Appendix 5)

The vehicle frame structure according to any one of Appendices 3 to 5, in which:
the front ribs and the rear ribs are provided in a plurality; and
the front ribs and the rear ribs are radially disposed.

What is claimed is:

1. A vehicle frame structure comprising:
a frame main body that is integrally cast to include a wheel house section;
a flange section provided along an upper edge of the wheel house section;
an inclined surface provided in an upper portion of the wheel house section and below the flange section, the inclined surface being provided with a through-hole; and
one or more reinforcing ribs that connect the inclined surface and the flange section.

2. The vehicle frame structure according to claim 1, wherein a plurality of the reinforcing ribs is provided, and each of the reinforcing ribs is connected to a ridge line between the inclined surface and a surface adjacent to the inclined surface.

3. The vehicle frame structure according to claim 2, wherein a front rib is provided forward of the reinforcing ribs in a vehicle front-rear direction and a rear rib is provided rearward of the reinforcing ribs in the vehicle front-rear direction, in the flange section.

4. The vehicle frame structure according to claim 3, wherein:
the flange section is arch-shaped; and
the through-hole is provided in an uppermost portion of the wheel house section.

5. The vehicle frame structure according to claim 4, wherein:
a plurality of the front ribs and a plurality of the rear ribs are provided; and
the front ribs and the rear ribs are radially disposed.
